(19) United States
(12) Patent Application Publication
(10) Pub. No.: US 2014/0154025 A1
(43) Pub. Date: Jun. 5, 2014

(54) EXPANSION BUSHING DOWEL

(71) Applicants: Aurelie Bergez, Valence (FR); Alain Gauthier, Saint-Jean-de-Muzols (FR); Jean-Paul Barthomeuf, Alixan (FR)

(72) Inventors: Aurelie Bergez, Valence (FR); Alain Gauthier, Saint-Jean-de-Muzols (FR); Jean-Paul Barthomeuf, Alixan (FR)

(21) Appl. No.: 14/003,731

(22) PCT Filed: May 7, 2012
(86) PCT No.: PCT/IB12/52268

§ 371 Date: Feb. 17, 2014

(30) Foreign Application Priority Data
Mar. 7, 2011 (FR) 1151856

(51) Int. Cl. F16B 13/06

(52) U.S. Cl. CPC F16B 13/063
USPC 411/44

(57) ABSTRACT

The dowel comprises:
i) a stem with, at one end, fastening means and, at the other end, an expansion cone; and
ii) an expansion bushing mounted around a portion of the stem adjacent to the expansion cone and through which the expansion cone is intended to be moved so as to anchor the dowel into an anchoring hole of a supporting material. According to the invention, the expansion bushing is free of slits and drilled with expansion holes along an opening area of the bushing.

The present invention relates to an expansion bushing dowel for fastening a part to a supporting material.

An expansion bushing dowel comprises i) a stem with, at one end, fastening means and, at the other end, an expansion cone and ii) an expansion bushing mounted around a portion of the stem adjacent to the expansion cone and through which the expansion cone is dedicated to be moved for anchoring the dowel inside an anchoring hole of the supporting material.

Such dowels are generally used in a concrete support after a reception hole being drilled therein. As fastening means, namely for fastening the part to the support, an additional thread is still generally provided.

Still generally, the expansion bushings comprise expansion axial slits that were provided for promoting their opening out and their expansion during their cooperation with the expansion cone of the stem.

Such expansion slits often end with holes or eyelets also adapted to avoid the tear of the bushing skirt.

It is known from the document US 2010/0104393 an expansion dowel bushing, the bushing of which does not comprise any expansion slit with, as a result, a reduced risk of rupture cone in the supporting material, since the expansion effort is more important when there is no slit.

Thus, slotted and drilled expansion bushing dowel and full expansion bushing dowels are known.

As a result, the Applicant got the idea to try to know if an expansion bushing being only drilled and without any slit, would not be satisfactory. They were quite right to do so.

A hole area within the bushing offers at lesser cost a natural curvature area favourable to the bushing skirt opening out during its expansion. Drilling holes is easy and not expensive to solve the problem of the curvature and the opening of the bushing.

Thus, the present application relates to an expansion bushing dowel of the above defined type, characterized by the fact that the expansion bushing is slit-free and drilled with expansion holes along an opening zone of the bushing.

The bushing can comprise only two holes, but it can have more.

Preferably, the bushing comprises, on its edge turned to the fastening means of the stem, anchoring studs arranged to be anchored in the anchoring hole wall particularly when the bushing stem is started to be drawn on, which avoids that the bushing rises in the anchoring hole with the stem.

Advantageously, the bushing has a frustoconical shape of bigger diameter on its edge turned to the fastening means of the stem, so that, when there are anchoring studs, they come immediately and also more certainly to be anchored in the anchoring hole wall as soon as the dowel stem is drawn on.

Preferably, the expansion holes are regularly distributed around said bushing, so that the bushing deformation is homogeneous. With the same view, the anchoring studs can be distributed in a regular way on the periphery of the corresponding edge of the bushing, in order to secure a uniform link around the anchoring hole.

Advantageously, the bushing is made of a metal sheet blank within which expansion holes and anchoring studs are arranged and which is shaped as an annular skirt, for instance by crimping, around the concerned portion of the stem.

Furthermore, the stem can show an outer radial shoulder, such as a collar, forming an axial abutment for the bushing upon the rising up of the dowel in the anchoring hole.

The invention will be better understood by means of the following description of a preferred embodiment of the dowel according to the invention, referring to the appended drawings, wherein:

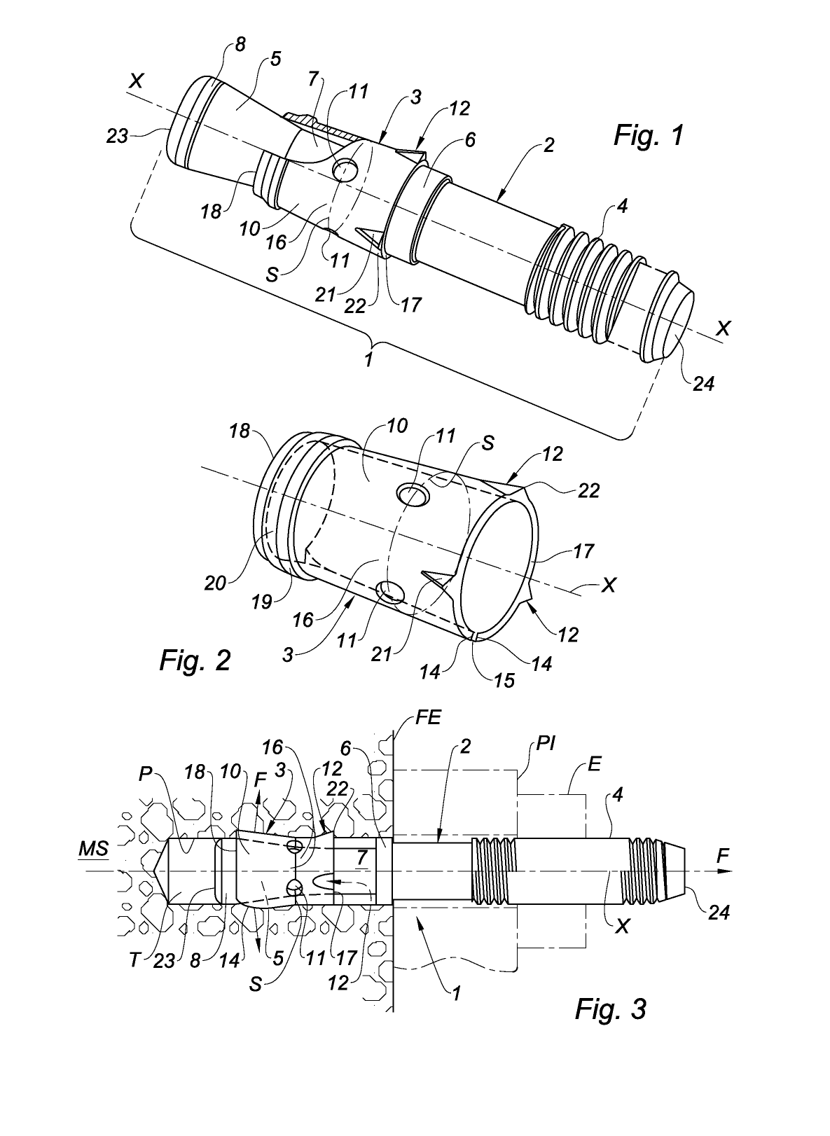

FIG. 1 is a partially exploded perspective view of the expansion bushing dowel;

FIG. 2 is an enlarged perspective view of the expansion bushing with its expansion holes and anchoring studs; and

FIG. 3 is a profile view of the dowel after its mounting inside a reception hole in a supporting material.

The dowel 1 of FIG. 1, intended for fastening a part on a supporting material, comprises a stem 2 having a longitudinal axis X and an expandable bushing 3 coaxially mounted around this one.

The stem 2 shows, at one end, means 4 for fastening the part as a thread in this example and, at the other end, an expansion cone 5 for anchoring the bushing 3, and accordingly the dowel, in the supporting material. Generally, the stem 2 is metallic and has a solid section throughout its whole length.

Particularly, it is seen on FIG. 1 that the stem 2 comprises on its periphery and on the expansion cone 5 side, an outer radial shoulder in the shape of a collar 6 which is for instance intended to be used as an axial abutment for the bushing during the rising up of the dowel 1 in the supporting material. This collar 6 is linked to the cone 5 by an intermediate cylinder portion 7 of the stem, around which the expandable bushing 3 is mounted, as it will be subsequently seen.

The intermediate cylinder portion 7 extends with a constant diameter and is continued with the expansion cone 5 from which this latter is originated, to widen according to the desired taper and ends with a cylinder portion of a small (axial) width 8, the diameter of which is substantially equal to the diameter of the reception or anchoring hole drilled in the supporting material and to that of the collar 6.

The expansion bushing 3 of FIGS. 1 and 2 is usually obtained from a flat sheet blank (metallic in a general way), being cut and machined to present, once mounted on the intermediate cylinder portion 7 of the stem 2, the desired shape 10 provided, according to the invention, with expansion holes 11 and anchoring studs 12. The mounting of the expansion bushing 3 around the cylinder portion 7 is performed by crimping of the skirt 10 so that the end side edges 14 of the skirt 10 are near and parallel to each other, a very narrow slit 15 separating them.

As previously reminded, this expansion bushing 3 is intended to be partially crossed by the rigid expansion cone 5 of the stem 1 to be anchored, after deformation, within the wall P of the reception or anchoring hole T in the supporting material MS (FIG. 3).

In the skirt 10 forming the bushing 3 the expansion holes 11 are arranged for creating a area of lesser strength and thus, a curvature or opening zone 16 of the bushing, as will be seen later on. These expansion holes 11 are arranged on the bushing periphery, in a same normal cross-section S of this one, perpendicular to the longitudinal axis X of the stem 2, in order to define the desired opening area 16.

In the illustrated example, the expansion holes 11 are identical and are in a number of four, only two of which are visible on the Figs., and are angularly evenly distributed around the crimped annular skirt 10 of the bushing 3.

Their number could of course be different without departing from the scope of the present invention. Preferably, a number of at least two diametrically opposed holes is provided.

Furthermore, the holes 11 can also have a different shape, although a circular embodiment, as on Figs., is satisfactory. Their diameter is determined so as to obtain the desired expansion of the skirt. More or less oval, or even oblong holes in the direction of the normal cross-section S of the annular skirt promoting the curvature thereof can thus be contemplated. This section S is located at the mid-part of the bushing 3 opposed to the other mid-part turned to the cone 5, in order to enable an appropriate deformation by the opening out of the skirt with respect to the area 16 and a secure and reliable anchoring of the bushing.

Moreover, as can be seen on FIGS. 1 and 2, the side skirt 10 shows some tapering, so that the bushing 3 mounted around the portion 7 of the stem 2 has a frustoconical shape being reverse of that of the expansion cone 5 of the stem. The bushing tapering is in practice lower than that of the expansion cone of the stem. Thus, the end transverse annular edge 17 of high diameter (large base) of the frustoconical bushing is turned to the radial collar 6, that is the thread 4 of the stem, whereas the end transverse annular edge 18 of small diameter (small base) is on the expansion cone side 5 of the stem.

Dimensionally, the expansion bushing 3 has a higher length than that of the intermediate cylinder portion 7 and extends from the radial collar 6, against which the large transverse edge 17 applies, to the expansion cone 5, the small transverse edge 18 coming plumb with any normal section of the expansion cone 5 but, in this example, close to the cylinder portion. Once the skirt 10 is crimped, the bushing 3 is mobile, apart from the operating play, axially and in rotation with respect to the stem 2.

On the long transverse edge 17 side of the bushing anchoring studs 12 are located, protruding outside the outer periphery of the skirt 10. These studs 12 are identical and present, as shown on FIGS. 1 and 2, an arrow half-tip shape 21 coming from the skirt and gradually standing out of this one to end at the related edge 17 with a triangular section.

The number of these anchoring studs 12 is of three in this example, angularly spaced of 120° to each other around the lateral skirt 10. The shape and the number of studs could be different. It is also to be noticed that, in this example, the expansion holes 11 and the anchoring studs 12, that are respectively four and three in number, are angularly shifted between them. Of course their number could be identical so that the holes and the studs are thus aligned or shifted symmetrically to each other.

The radius defined between the top 22 of the protruding tip 21 of each stud 12 and the axis X is preferably somewhat higher than the hole T radius in the supporting material MS to maintain the bushing inside the hole wall at the dowel driving time, as will be seen herein below.

On the small transverse edge 18 side, the skirt 10 shows an outer peripheral shoulder 19 which extends here on the whole extension of the bushing and which is linked by a bevel 20 to the edge 18, enabling, on the one hand, the easy introduction of the bushing inside the hole and, on the other hand, the adjusted guiding thereof into the hole. This shoulder 19 has a diameter being substantially close to that of the portion 8 ending the expansion cone 5 and corresponding to its large base.

The positioning of the crimped expansion bushing 3 dowel 1 into the supporting material MS does not present any difficulties and is usually performed as follows.

Previously, as shown on FIG. 3, an anchoring or reception blind hole T is drilled in the generally hard supporting material MS (in concrete).

The depth of the hole T is at least equal to the dowel length comprised between the transverse face 23 ending the cone 5 of the stem and the collar (or shoulder) 6.

A dowel 1 is introduced, on the expansion cone 5 side, into the hole T through a tool, not illustrated, but such as a hammer, acting on the other opposed transverse side 24 of the stem 2. Together with the expansion cone 5 being driven into the hole T, the bushing 3 introduction occurs, axially pushed by the collar 6 of the stem. The bevel 20 and the shoulder 19 help for the introduction and the guiding of the bushing within the hole T.

The driving of the dowel 1 continues in order to completely introduce the bushing 3 into the hole T, with the anchoring studs 12 which have entered the hole wall P at their top 22, and this driving can end when the collar 6, the diameter of which is substantially equal to the portion 8 of the cone and thus to the hole, is introduced in this latter, coming for example substantially flush with the outer face FE of the supporting material MS.

The dowel 1 is then introduced into the hole T, with the expansion cone 5 ready to deform the bushing 3 for its total anchoring in the hole wall P.

For that, an axial traction is exerted according to the arrow F on the stem 2, towards the outside of the hole T, which traction is obtained by a clamping nut E, in mixed line on FIG. 3, screwed on the thread 4 and serving to fasten a part PI, also illustrated in mixed line and mounted on the stem 2 to abut against the face FE of the supporting material MS.

Upon threading the nut E, the expansion cone 5 of the stem 2 is drawn and enters the bushing 3 by the small transverse side 18, which bushing, due to its frustoconical shape reversed with respect to the cone, is submitted to an expansion at the very beginning of the traction effort exerted by the cone of the stem recoiling, at the level of the skirt 10 and the associated anchoring studs 12, the tips 21 of which engage the hole wall P. Thus, the bushing 3 is immediately axially immobilized in position, which avoids its rising up into the hole.

The expansion holes 11 create, at their normal section S perpendicular to the axis X, the curvature zone 16, since of lesser strength, in the skirt 10, promoting by the way the expansion and opening out thereof, as shown on FIG. 3.

The fact that the bushing 3 is open (slit 15) between its parallel lateral edges 14 of course participates in the skirt general expansion.

Thus, as the expansion cone 5 is entering the bushing, due to the nut E being screwed, so as to reach the final position illustrated in FIG. 3, for which the cone is substantially engaged into the bushing at least up to the level of the holes 11, the skirt 10 is submitted to such an expansion that it is forced to enter (arrows f) the wall P of the hole T, so that the bushing 3 is perfectly anchored in the supporting material MS thanks to the shoulder 19 and its sharp angle which extends on the whole extension of the bushing. As the section S is closer to the bushing edge 17, it can be seen that the main opening out of the skirt under the action of the cone occurs on a major part of the bushing, substantially comprised between the edge 18 and the curvature area 16 of lesser strength (section S) around which the skirt deformation occurs.

The dowel 1 is then operational, completely immobilized by the nut E being clamped for fastening the part PI to the supporting material, and reaches the object aimed at the expansion hole area provided in the bushing.

1. An expansion bushing dowel comprising:
i) a stem with, at one end, fastening means and, at the other end, an expansion cone; and
ii) an expansion bushing mounted around a portion of the stem adjacent to the expansion cone and through which the expansion cone is intended to be moved so as to anchor the dowel into an anchoring hole in a supporting material, the expansion bushing being free of slits,
characterized by the fact that the expansion bushing is drilled with expansion holes along an opening area of the bushing.

2. The dowel according to claim 1, wherein the bushing comprises two holes.

3. The dowel according to claim 1, wherein the bushing comprises, on its edge turned to the fastening means of the stem, anchoring studs arranged to be anchored into the anchoring hole wall.

4. The dowel according to claim 1, wherein the bushing has a frustoconical shape of a larger diameter on its edge turned to the fastening means of the stem.

5. The dowel according to claim 1, wherein said expansion holes are arranged in a section being normal to the bushing.

6. The dowel according to claim 1, wherein the expansion holes are regularly distributed around the bushing (3).

7. The dowel according to claim 3, wherein the anchoring studs are regularly distributed on the periphery of the corresponding edge of the bushing.

8. The dowel according to claim 1, wherein an outer peripheral shoulder is provided.

9. The dowel according to claim 3, wherein the expansion holes are of a circular shape and the anchoring studs have a half-tip shape protruding outside the bushing.

10. The dowel according to claim 1, wherein the bushing is made of a metal sheet blank within which expansion holes and anchoring studs are arranged and which has a ring-shaped skirt around the related portion of the stem.

11. The dowel according to claim 1, wherein the stem shows an outer radial shoulder forming an axial abutment for the bushing.
